(19) United States
(12) Patent Application Publication
(10) Pub. No.: US 2010/0294617 A1
(43) Pub. Date: Nov. 25, 2010

(54) COIN VERIFIER

(75) Inventors: Reto Straumann, Bern (CH); Martin Liechti, Bern (CH)

Correspondence Address: BIRCH STEWART KOLASCH & BIRCH, PO BOX 747, FALLS CHURCH, VA, 22040-0747, US

(73) Assignee: ACS Solutions Switzerland AG, Bern (CH)

(21) Appl. No.: 12/746,305

(22) PCT Filed: Dec. 4, 2008
(86) PCT No.: PCT/CH08/00514

§ 371 Date: Jul. 9, 2010

(30) Foreign Application Priority Data
Dec. 7, 2007 (EP) 07405349.7

(51) Int. Cl. G07D 5/00

(52) U.S. Cl. 194/302

(57) ABSTRACT

The invention relates to a coin verifier which comprises a support for supporting a coin during verification. The coin verifier is characterised in that the support comprises two shutters which are arranged opposite to each other. The shutters support the coin in a v-shaped manner when closed. The inventive coin verifier comprises a recess for retaining a coin during verification and is characterised in that the recess is terminated by two outlets. The outlets are closeable by the shutters for selectively dumping the coin through one of the two outlets. Further, a method for verifying a coin is disclosed which comprises the steps of maintaining/retaining the coin in a retainer equipped with sensors, verifying the coin by the sensors and selectively opening one of two shutters. The choice of the shutter which is opened depends on the result of the verification, in particular whether or not the coin is accepted.

### TECHNICAL FIELD

The invention relates to a coin verifier comprising a support for supporting a coin during verification and a method for verifying a coin using such a coin verifier.

### BACKGROUND ART

In general, there are several examples of coin verifiers with a support for supporting a coin during the verification process. Some of them centre a coin or bring the coin into a defined position, respectively, prior to perform the actual verification of the coin. After verification and depending on the result of the verification process, the coin needs to be guided to a destination such as a coin magazine, a plurality of coin magazines or a general change container. Generally the wording “coin” does not only comprise currencies but also tokens, chips or similar objects.

The publication EP 0 508 560 B1 (ACT GmbH) describes a device and a method for verifying coins. The method comprises the steps of determining the diameter of the coin, the coinage and the composition of the coin. It uses inductive as well as optoelectronic means to determine these features of the coin. During a verifying cycle, the coin is being centred by a plurality of arms which are driven by rotation of two concentric disks which rotate about the same geometric axis. The arms move continuously towards the centre of the disks and thereby centre the coin on the disks. By this centring, simultaneously the diameter of the coin is determined. The determination of the coinage and composition of the coin is done by optoelectronic means and using inductive methods, respectively.

EP 1 146 489 A2 (ACT GmbH) describes a sensor device for such an inductive measuring method. The device comprises a sensor array with a plurality of sensor elements arranged periodically and thereby forming a matrix of sensors. Using this device, a coin which is positioned in front of the array of sensors can be scanned by selectively activating individual sensor elements. The result of the determination of the coin can be improved by keeping the coin and the sensor array in a constant relative position.

The cited devices do not comprise a mechanism to further guide a determined coin to its destination which is depending on the result of the verification process. It is therefore necessary to combine the verifier with further devices which further process the coin depending on the result of the verification. This in turn requires a data connection as well as a mechanical connection between the verifier and a successive guiding mechanism.

Moreover, such a construction is space consuming and expensive. Particularly for compact apparatuses such as e. g. ticketing machines, the size of the coin verifier plays an important role.

### SUMMARY OF THE INVENTION

The object of the invention therefore is to construct a coin verifier which integrates a mechanism to reliably verify a coin and to mechanically initiate the further processing of the coin.

The object is achieved by the features of claim 1. The support of the coin verifier comprises two shutters arranged opposite to each other in order to support the coin in a v-shaped manner.

As the coin is supported by two shutters which are arranged opposite in a v-shaped manner, the coin is reliably supported on the one hand. On the other hand, by opening one of the shutters the coin can be released to the respective direction. Hence, the coin verifier itself initiates and determines the further processing of the coin by opening a respective shutter depending on the result of the verification.

Alternatively, the object is achieved in that the coin verifier comprises a recess for retaining a coin during verification. The recess is terminated by two outlets which are closeable by shutters for selectively dumping the coin through one of the two outlets. This embodiment further specifies the invention but can also be realised independently. The outlets of the recess may lead to different destinations, such as distinct coin magazines, so the selective dumping of the coin results in a selection of distinct destinations of the coin.

In a preferred embodiment, the shutters of the coin verifier are support plates. Such plates can easily be arranged in a v-shaped manner opposite to each other. Plates are cheap in production and do not require a complex mechanism to be moved. Further, plates form reliable supports for coins of different sizes. Such support plates do not need to be planar but can also be curved. In case of one or more curved support plates, the v-shape of the arrangement of the support plates applies to an arrangement of the tangents of the respective support plate. The respective tangent of the support plate is defined by a point on the support plate e. g. the contact point where a coin is contacting the support plate when being supported by it and the curvature of the support plate in the respective point.

As an alternative for using support plates as shutters, two pins can also be used in order to support a coin. The pins then may be arranged such that the planes being defined by each pin and the respective direction of a tangent to an appropriate coin at the position of the pin are arranged in a v-shaped manner. An appropriate coin is such a coin the diameter of which is greater than the distance between the pins. Such pins then can also be opened selectively in order to further process the coin after its verification. In this context, “pin” can also be interpreted as a round, circular or ring shaped object with a diameter of a similar size to the length of a support plate.

In a further preferred embodiment of the invention a mechanism alternatively opens the shutters. Such a mechanism allows for a selection of the further guiding of a coin inside of the coin verifier by the selection of the shutter to be opened. Hence, the destination of the coin which is determined by the direction in which the coin is released can be chosen selectively.

Alternatively, such a mechanism is not essential as a coin could also be released without such a mechanism. Instead of such a mechanism one can think of another one which guides a coin into a certain direction e. g. by actively moving a coin rather than just partially releasing its support.

In a further preferred embodiment, the coin verifier comprises an integrated coin guiding channel. Such a guiding channel is preferably integrated into a base plate of the coin verifier and ensures that the coin is safely guided from the inlet into the recess of the coin verifier where the actual verifying process takes place and further out of the coin verifier into a direction which depends on the result of the verification of the coin. That the guiding is integrated into the base plate leads to fewer parts being necessary for the construction of a coin verifier which means lower production costs. Here, integrated into a base plate means that the coin guiding channel and the base plate are one sole physical element.

Alternatively, the verifier can be constructed without an integrated coin guiding channel. However, in this case a separate coin channel may be attached to the coin verifier.

In a preferred embodiment, the coin verifier comprises a pivoted arm for clamping a coin to be verified in cooperation with the shutters and/or for pushing a coin past an open shutter. The pivoted arm may press the coin towards one or both of the shutters. Hence, the arm works in cooperation with the shutters and by doing so fixes the coin that is to be verified. After verification, one of the shutters is opened and hence allows the verified coin to leave the verifier. However, there are situations where a coin is not proceeding advanced by gravitational force only. Such a situation might occur if a coin is draggled e. g. covered by a sticky substance. In this situation the arm can also actively push the coin past an open shutter.

Alternatively, such an arm is not necessary. As a variant, for example a slider may also press the coin against one or both of the shutters hence fixing the coin. As a further variant a clamping plate can fix the coin which presses against the coin in an axial direction whereas axial means perpendicular to the faces of the coin. Such a clamping plate therefore would press the coin against the base plate of the verifier.

In a further preferred embodiment, the pivoted arm is connected to a step motor for pivotal action. A step motor is a simple and cheap device to drive an element in a rotatable manner about a defined angle. Step motors are more durable and have fewer parts which need maintenance than DC-motors. Using a step motor for rotation, the arm can directly be driven to any angularity.

Alternatively, any other device for rotating the arm is possible. Some possible realisations are a spring drive or a DC-motor, preferably in connection with a gear such as e. g. a worm gear.

In another preferred embodiment, the coin verifier comprises a clamping magnet for axial clamping a coin during the verification process. Axial clamping means that the clamping magnet acts on the coin in a direction which is perpendicular to the faces of the coin which essentially forms a flat cylinder with two faces and a cylinder barrel. Hence, the coin is pressed against the base plate. Such a clamping of the coin ensures a save fixing of the coin which can be performed in addition to the fixing by a pivoted arm or as sole fixing mechanism.

Alternatively, the coin can be fixed by a previously described arm only or may not require a fixing at all. However, some sort of fixing of the coin is preferred. Further, the coin can be clamped axially by a device other than a clamping magnet.

Further preferably, the clamping magnet acts on a clamping plate. This means that the clamping plate is mounted on the clamping magnet. It transfers the force of the clamping magnet to the clamped coin. The clamping plate presses the coin against the base plate. Using a clamping plate enables the clamping magnet to act on coins of different sizes. This also ensures a save axial clamping across the whole face of the clamped coin. The clamping plate may be made of a non-magnetic material.

Alternatively, the clamping magnet can also directly act on the coin or it can clamp the coin via another element such as a clamping pin or clamping pillar.

In a preferred embodiment, the shutters of the coin verifier are driven by lift magnets. Such magnets allow a compact realisation of the coin verifier as the mechanical part of the driving mechanism for the shutters is small. Further, they can easily be addressed by an electronic control unit. Lift magnets act fast and precisely and thereby provide a fast and precise way of processing coins.

As a variant, the shutters may also be driven by another mechanism. For example, it is possible to drive the shutters using DC-motors or step motors.

In a preferred embodiment the coin verifier comprises a sensor array, preferably a triangularly shaped sensor array. The determination of a coin can be performed more efficiently and more reliably by such a sensor array. In particular, a sensor array fits to a plurality of different sizes of coins as the sensors are distributed over the (e. g. triangular or square) area of the sensor array rather than being at a single position. Therefore the sensor array can be used to determine more different sorts of coins than single sensors at certain positions within the coin verifier. Moreover, using an array of sensors not only a measurement of optical or inductive characteristics of a coin but also a determination of the size of a coin can be performed at a time depending on which sensors can measure a part of a coin.

Alternatively, a sensor array which covers a non-triangular shaped area as well as single sensors which are not arranged in an array may be used.

According to a further embodiment, a sensor array comprises inductive sensors. In particular, all sensors of the sensor array are inductive sensors. Such an array of inductive sensors can determine the composition of a coin at the distinct positions of the sensors which are distributed across the surface of the coin. In addition, the size of a coin can be determined using the same array of sensors. Whether a sensor is partly covered, completely covered or not covered gives information about the size and shape of the measured coin. Hence, using an array of inductive sensors is sufficient to determine the type of the coin on the basis of the distribution of the composition and the size of it.

Alternatively, the array may comprise different sensors such as optoelectronic or capacitive ones or a combination of different kinds of sensors.

A method for verifying a coin comprises the steps of maintaining or retaining the coin in a retainer equipped with sensors, verifying the coin by the sensors and selectively opening one of two shutters depending on the result of the verification, in particular whether or not the coin is accepted or rejected. An advantage of this method is that the coin is not only verified but also directly processed by the verifier. In particular the coin is mechanically directed to its destination by the verifier itself. Hence, the whole system comprising the coin verifier can be constructed in a more compact way. The opening of one of the two shutters may also depend on the charging level of magazines adjacent to the coin verifier.

In a preferred method for verifying and processing a coin, the destination of the coin is controlled solely by the respective shutter which is opened after the analysis of the sensor reading. Each shutter opens a guide or chute to a certain destination of the coin such as a certain drum of the coin magazine. By opening a certain shutter, the coin follows the respective guide only, rather than the other guide. Hence, the destination and further processing of the coin is determined by opening one of the two shutters. The mechanical effort to fully process the coin from its inlet to its destination is thereby reduced considerably.

Alternatively, it is possible that the selective opening of the shutters does not completely determine the destination of the coin as further switches in the adjacent guides may be provided.

Preferably, the coin is clamped during processing or verification. Because the coin is not moving relative to the sensors, the sensors measure a fixed portion of the coin and hence the quality of the verification process is improved. The clamping preferably is provided by pressing the coin against the shutters and/or the array of sensors of the verifier. Then the position of the sensors with respect to the coin is constant which means that the respective position of the coin that is measured by each sensor is not changing. Therefore, a possible measured change in the composition of the examined portion of the coin which could result from moving the coin can be excluded. Such change e. g is relevant for bi-metallic coins with one metal or alloy in an outer ring around a contrasting centre or for sensors which are partly covered by a coin. A possible movement of the coin can result from external shocks to the verifier which can occur e. g. if the verifier is situated within a moving vehicle.

As a variant, the coin can be determined without being clamped. In a coin verifier that is not affected by external or internal shocks during the measuring process, the coin rests still and safely on the support.

In a more preferred method, the verification process involves two distinct and delayed measurements of the coin. Two distinct measurements which are delayed lead to two distinct results which improve the quality of the total result of the verification process as the errors of each single measurement can be reduced statistically. Generally, by measuring a single value more than once, statistical errors can be reduced. In order to keep the process of examination as short as reasonably possible, the number of measurements needs to be restricted. A number of measurements of two evolved as a reasonable value. However, if there are differences beyond a predefined value between two delayed measurements, additional measurements may be provided.

Alternatively, the verification process can comprise only one measurement as well as a higher number of measurements depending on the precision of the total measurement and the time which is acceptable to be consumed by the examination of a coin.

Preferably, the coin is disengaged and clamped between the distinct and delayed measurements. First, the coin is clamped and a first measurement is performed. After the first measurement, the coin is disengaged and clamped again and afterwards a second measurement is performed on the clamped coin. Hence, two independent measurements are performed leading to a more reliable result of the verification. Compared with an examination comprising two distinct measurements but without the step of disengaging and clamping the coin between the respective measurements, the error in the position of the coin relative to the sensors can be reduced. If the verifier is moved during the measuring process, a coin could be moving inside the recess as opposed to resting on the supports. This in turn could lead to fixing the coin in a position other than its usual position when resting on the supports. An imprecise determination of the size of the coin could be the result of such a faulty position of the coin. It further probably inhibits a correct determination of the value of the coin. By disengaging and clamping the coin, errors in the position of the coin relative to the sensors can be detected and their effect on the result of the verification process can be reduced.

It is also possible to measure a coin twice but without releasing and clamping it between the measurements. If the coin verifier is not moved and is unlikely to be exposed to external shocks, a movement of the coin inside the recess is also unlikely. As the coin most probably will rest still and safely on the supports, there is no particular necessity for correcting its position.

Preferably, the verification of the coin involves an inductive measurement. Advantageously, an inductive measurement determines the composition of the material the coin is made of. When using an array of sensors, the size and to a certain extend the shape of a coin can also be determined by the inductive measurement. Hence, such a measurement performed by using an array of inductive sensors may be sufficient to fully determine the type of a coin. Therefore, no additional measuring processes or additional sensors are necessary to determine the type of the coin.

Alternatively, other sensors such as optoelectronic or capacitive sensors can be used to perform one or more measurements on the coin.

From the following detailed description and the sum of patent claims, further preferred embodiments and combinations of features of the invention arise.

### BRIEF DESCRIPTION OF THE DRAWINGS

The drawings for illustration of the preferred embodiments show:

FIG. 1 A perspective view drawing of the coin verifier in a housing;

FIG. 2 a side view of the coin verifier with magnets and a step motor;

FIG. 3 a top view of the base plate with components inside the coin verifier;

FIG. 4 a schematic view of a sensor array designed according to the invention; and

FIG. 5 a flow diagram of the verifying and processing method.

In general, equal parts are identified with identical numbers.

### PREFERRED EMBODIMENTS

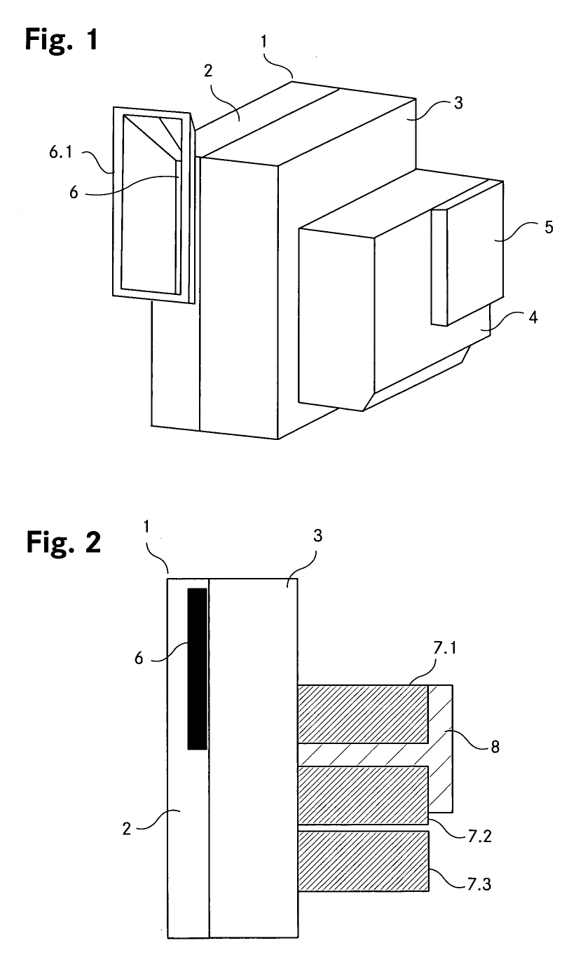

FIG. 1 shows a perspective view drawing of the coin verifier 1 in a housing. The housing of the coin verifier 1 comprises a base plate 2. It further comprises a housing of a recess 3 for retaining a coin during verification as well as a housing of the peripherally attached magnets 4 and a step motor 5. The housing of the recess 3 is directly attached to the base plate 2 such that the two of them form a cuboid. Attached to the housing of the recess 3 is the housing of the magnets 4 which encloses lift magnets and a clamping magnet. This housing of the magnets 4 is also cuboid-shaped and comprises a bevelled edge. It may enclose a plurality of magnets as well as a step motor. The step motor may extend further from the housing of the recess 3 than the magnets do. Hence, a further housing 5 may be necessary for the step motor, whereas the housing of the step motor 5 is to be attached to the housing of the magnets 4. The housing of the step motor 5 may also be cuboid-shaped. The base plate 2 further comprises a coin inlet 6 with an extending hopper 6.1. The coin inlet 6 is situated on one face of the base plate 2. The face of the base plate 2 where the coin inlet 6 is situated on is oriented perpendicular to the face of the base plate 2 to which the housing of the recess 3 is attached.

FIG. 2 shows a side view of the coin verifier 1 with magnets 7.1 . . . 7.3 and a step motor 8. The coin verifier 1 comprises the base plate 2 and the attached housing of the recess 3. Further attached to the housing of the recess 3 are three magnets 7.1, 7.2 and 7.3 as well as the step motor 8. The magnets 7.1 . . . 7.3 are extending perpendicular to the face of the housing of the recess 3 to which they are attached. Again, a coin inlet 6 is situated at one side of the base plate 2 which is oriented perpendicular to the face of the base plate 2 to which the housing of the recess 3 is attached. The magnets 7.1 . . . 7.3 are used for moving the shutter plates and the clamping plate inside of the housing of the recess 3. The step motor 8 is joined with the pivoted arm inside of the housing of the recess 3.

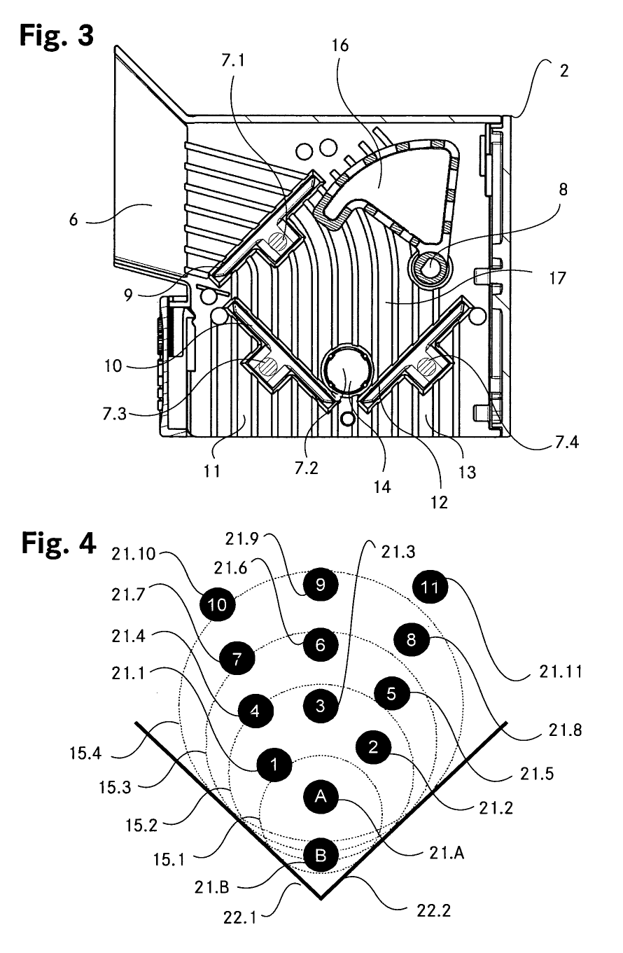

FIG. 3 shows a top view of the base plate 2 with some internal components of the coin verifier. The base plate 2 comprises a coin inlet 6 and two outlets 11, 13. Next to the coin inlet 6 there is a shutter plate 9 which can be lifted by a magnet 7.1. The shutter plate 9 blocks the section of the guiding of the base plate 2 which is attached to the coin inlet 6 and advances towards the recess 17 where the verification process takes place. The blocking of the recess is particular useful when a coin is examined. However, if the shutter plate 9 is lifted, a coin can be fed into the recess 17 of the coin verifier.

During verification a coin which is to be verified is clamped by a pivoted arm 16 as well as by a clamping plate 14. The pivoted arm 16 is attached to an edge of the recess 17. During the verification process of a coin, the pivoted arm 16 presses the coin against further shutter plates 10, 12 and thus fixes the coin in its radial directions. The clamping plate 14 which is driven by a further magnet 7.2 presses the coin against the sensor array which is positioned opposite to the base plate 2. The clamping plate 14 is circularly shaped and dimensioned such that it is capable of pressing any reasonable coin size against the sensor array. In one embodiment, the clamping plate 14, pressing the coin to be verified in its axial direction, is also used to determine the thickness of the coin.

The thickness of a coin can indirectly be measured by the clamping plate 14 using a further plate (not shown) which is connected to the clamping plate 14 and which therefore moves with the clamping plate 14. This further plate can be made of a metal such as copper and be moving against a further inductive sensor (not shown). The inductive sensor measures the distance between the copper surface and the sensor itself and hence deduces the thickness of the coin being clamped by the clamping plate 14.

The recess 17 has a square shape and is limited by three shutter plates 9, 10, 12 which build three edges of the square. The square-shaped recess 17 is situated such that one corner points towards that edge of the base plate 2 which comprises two outlets 11, 13. The shutter plates 10, 12 which are situated next to that corner support the coin to be verified. They are arranged opposite to each other in a v-shaped manner in order to support the coin. At that edge of the square-shaped recess 17 where there is no shutter plate the pivoted arm 16 is positioned and mounted such that it can be rotated by a step motor 8 about an axis hence advancing into the recess 17 in order to clamp a coin. Further, the pivoted arm 16 can push a coin out of the recess 17 once at least one of the shutter plates 10, 12 has been opened. FIG. 3 shows the pivoted arm 16 in a retracted position. However, being pivoted into the recess 17, the arm 16 reaches coins of any reasonable size, whereas reasonable size at least means any currency coin but also tokens, chips or similar sorts of coins. If one of the magnets 7.3, 7.4 lifts one respective shutter plate 10, 12, the coin 15.1, 15.2 which lies inside the recess 17 is released through the respective outlet 11, 13 or pushed out of the recess, respectively.

FIG. 4 shows the projections 22.1, 22.2 of the shutter plates 10, 12 into a plane which is parallel to and opposite of the base plate 2 of the coin verifier. More precisely, FIG. 4 shows the projections of the surfaces of these plates 10, 12 which point towards the recess 17 of the coin verifier. The projections 22.1, 22.2 are arranged perpendicularly to one another and intersect in an L-shaped manner at the lowermost point of FIG. 4. The figure further shows four coins 15.1 . . . 15.4 which are clamped in the coin verifier. The coins 15.1 . . . 15.4 vary in size of their diameter from the smallest coin to be verified 15.1 up to one of the biggest ones 15.4. Each coin 15.1 . . . 15.4 touches both of the projections 22.1, 22.2 as they are pressed against the shutter plates 10, 12 towards the point where the projections 22.1, 22.2 intersect. This determines the exact position of each coin 15.1 . . . 15.4.

FIG. 4 further shows a sensor array comprising 13 individual sensors 21.1 . . . 21.11, 21.A and 21.B. The sensors 21.1 . . . 21.11, 21.A and 21.B lie in the same plane as the projections 22.1, 22.2. The sensors 21.1 . . . 21.11, 21.A and 21.B are distributed over an area of a substantially triangular shape. One of the corners of the triangle points downwards towards the intersection of the two projections 22.1, 22.2 of the shutter plates 10, 12. Provided that the coins 15.1 . . . 15.4 are localised in a defined position, the array of sensors 21.A, 21.B, 21.1 . . . 21.11 is set up such that at least one sensor 21.A is always covered by a coin 15.1 . . . 15.4 of any size. Further, as the size of the coins 15.1 . . . 15.4 to be verified increases, the number of sensors 21.A, 21.B, 21.1 . . . 21.11 covered by a coin 15.1 . . . 15.4 increases. The arrangement of the sensors 21.A, 21.B, 21.1 . . . 21.11 ensures that at least one of them is always partly covered by a coin 15.1 . . . 15.4 of any size.

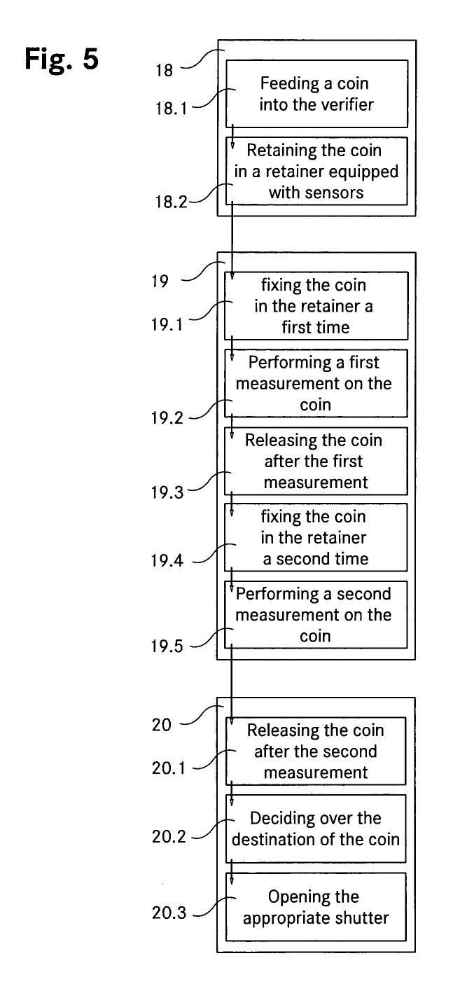

FIG. 5 shows a flow diagram of the verifying and processing method. The processing method can be divided into three general stages 18, 19, 20. At first, the coin is guided to sensors 18 and retained in the verifier in order to verify the coin, then the coin is verified 19 and afterwards the coin is selectively guided to its destination 20. These three general stages 18, 19, 20 can further be divided into elementary steps 18.1, 18.2, 19.1, . . . 19.5, 20.1, . . . 20.3. First of all the coin is being fed into the verifier 18.1 and guided towards a retainer. The coin is retained in the retainer which is equipped with sensors 18.2.

The next step directly relates to the actual verification stage 19. The coin is being fixed 19.1 e. g. by a clamping device. This fixing 19.1 ensures a reliable measurement which is performed as soon as the coin is fixed 19.2. After the first measurement 19.2, the coin is released again 19.3. By releasing the coin, the position in which the coin was fixed may change indicating that this specific position was not the rest position. The rest position is that position where the coin rests if there are no shocks, acceleration or like influence on the coin. After releasing the coin 19.3, it is fixed a second time 19.4. Subsequently, a second measurement is performed on the coin 19.5 in order to double check and/or correct the first measurement 19.2.

After the second measurement 19.5, the coin is released again 20.1. Depending on the results of the measurements 19.2, 19.5, the coin verifier decides over the destination of the coin 20.2. The destination may be e. g. a specific part of the magazine. If a coin cannot be verified as being acceptable, the destination may also be an output guide. Depending on the decision over the destination of the coin, the appropriate shutter is opened 20.3 and the coin is guided to this destination.

The arrangement and design of the components, in particular of the housings can be changed such that the housings do not need to be cuboids as shown in FIG. 1. Depending on where the verifier is positioned in a coin processing system, the dimensions of the verifier need to be adapted to other components of the system. The coin inlet and coin output openings can also be arranged differently. The hopper as shown in FIG. 1 is not necessary either but makes feeding the verifier more comfortable. The pivoted arm for clamping the coin can also be adjusted and arranged differently. However, it is important that the arm can clamp a wide variety of sizes of coins to be verified. The clamping plate can be designed differently such that it has a square, rectangular, circular or other shape.

In conclusion, the invention provides a coin verifier which integrates a mechanism to reliably verify a coin and to mechanically initiate the further processing of the coin.

1. Coin verifier comprising a support for supporting a coin during verification, characterised in that the support comprises two shutters arranged opposite to each other in order to support the coin in a v-shaped manner when closed.

2. Coin verifier comprising a recess for retaining a coin during verification characterised in that the recess is terminated by two outlets closeable by shutters for selectively dumping the coin through one of the two outlets.

3. Coin verifier as recited in claim 1 or 2, characterised in that the shutters are support plates.

4. Coin verifier as recited in claim 1 or 2, characterised by a control to alternatively open the shutters.

5. Coin verifier as recited in claim 1 or 2, characterised in that it comprises an integrated coin guiding channel

6. Coin verifier as recited in claim 1 or 2, characterised in that it comprises a pivoting arm for clamping a coin to be verified between the aim and the shutters and/or for pushing a coin past an open shutter.

7. Coin verifier as recited in claim 6, characterised in that the arm is connected to a step motor for pivotal action.

8. Coin verifier as recited in claim 1 or 2, characterised in that it comprises a clamping magnet for axial clamping a coin during a verification process.

9. Coin verifier as recited in claim 8, characterised in that the clamping magnet acts on a clamping plate.

10. Coin verifier as recited in claim 1 or 2, characterised in that the shutters are driven by lift magnets.

11. Coin verifier as recited in claim 1 or 2, characterised by a sensor array, preferably a triangularly shaped sensor array.

12. Coin verifier as recited in claim 11, characterised in that the sensor array comprises inductive sensors, in particular that all sensors of the sensor array are inductive sensors.

13. Method for verifying a coin, comprising the steps of:
maintaining/retaining the coin in a retainer equipped with sensors,
verifying the coin by the sensors,
selectively opening one of two shutters depending on the result of the verification, in particular whether or not the coin is accepted.

14. Method as recited in claim 13, characterised in that solely the choice of the respective shutter which is to be opened controls the destination of the coin.

15. Method for verifying a coin using a coin verifier as recited in claim 6, characterised in that the coin is clamped during processing/verification of the coin.

16. Method as recited in claim 15, characterised in that the verification process involves two distinct and delayed measurements of the coin.

17. Method as recited in claim 16, characterised in that the coin is disengaged and clamped between the distinct and delayed measurements.

18. Method for verifying a coin using a coin verifier as recited in claim 12, characterised in that the verification of the coin involves an inductive measurement.

19. Method for verifying a coin using a coin verifier as recited in claim 8, characterised in that the coin is clamped during processing/verification of the coin.

20. Method as recited in claim 19, characterised in that the verification process involves two distinct and delayed measurements of the coin.

21. Method as recited in claim 20, characterised in that the coin is disengaged and clamped between the distinct and delayed measurements.
